(19) United States
(12) Patent Application Publication
(10) Pub. No.: US 2026/0320555 A1
(43) Pub. Date: Oct. 15, 2026

(54) A METHOD AND SYSTEM FOR IDENTIFYING A GARMENT

(71) Applicant: My Club Europe Plc, Oxted (GB)

(72) Inventors: Neil Riches, Oxted (GB); Tony Fish, Oxted (GB); Alfonso Gironella, Oxted (GB); Graham Anderson, Oxted (GB); Dizzy Riches, Oxted (GB)

(21) Appl. No.: 19/486,333

(22) PCT Filed: Apr. 24, 2024
(86) PCT No.: PCT/GB2024/051057

§ 371 Date: Nov. 20, 2025

(30) Foreign Application Priority Data
May 22, 2023 (GB) 2307656.5

(51) Int. Cl. G06Q 10/087; G06K 7/14

(52) U.S. Cl. CPC G06Q 10/08774; G06K 7/1413; G06K 7/1417

(57) ABSTRACT

A method for identifying a garment, comprising receiving a first message in response to an identification code on the garment being scanned; obtaining a user identifier relating to a user of the garment and/or a garment identifier relating to the garment based on the first message; sending a second message to a user device to confirm the identification of the garment based on the user identifier and/or the garment identifier.

### FIELD OF THE INVENTION

The present disclosure relates to a method and system for identifying a garment.

### BACKGROUND

Every year, countless pounds of sports garments are misplaced or lost, leading them to eventually end up in local thrift stores and recycling centres.

In the past, mothers used to sew tags with their child's name on their belongings, hoping that someone would contact them if the items were lost. However, such methods are not practical. For example, sewing a small tag with just the child's name might not provide enough contact information for someone to reach out if the item is lost. Also, sewing individual tags onto multiple items of clothing can be time-consuming and the tags sewn onto garments can be easily removed or damaged during regular use. In addition, sharing personal contact information openly on a garment can raise privacy concerns.

In order to mitigate the need for expensive replacements and tackle the difficulties related to tracking and identifying lost items, it is important to establish an efficient, convenient, and secure method and system for identifying a garment that allow individuals who find lost sports kits to promptly inform the players who have lost them.

### SUMMARY OF THE INVENTION

Aspects of the invention are as set out in the independent claims and optional features are set out in the dependent claims. Aspects of the invention may be provided in conjunction with each other and features of one aspect may be applied to other aspects.

A first aspect of the disclosure provides a method for identifying a garment, comprising
receiving a first message in response to an identification code on the garment being scanned;
obtaining a user identifier relating to a user of the garment and/or a garment identifier relating to the garment based on the first message;
sending a second message to a user device to confirm the identification of the
garment based on the user identifier and/or the garment identifier.

Embodiments of the disclosure allow the method to identify a lost garment when it is discovered by a finder, notify the owner about the identification of the garment and arrange collection. By using an identification code, personal contact information remains confidential while still allowing the finder to reach out to the owner of a lost garment.

In some examples, this method may also be utilised by workplace members or even high street sales retailers who wish to retain a relationship with their members.

It can be understood that the method may be applied to manufacturing other types of goods and used by manufacturers to register and identify the ownership of the goods. For example, the types of goods may comprise bags such as backpacks and tote bags, luggage such as suitcases, accessories such as jewelleries, belts, wallets and shoes; and portable electronic devices such as mobile phones, laptops, tablets and smart watches. Optionally, the method may comprise creating the identification code based on the user identifier and/or the garment identifier. Embodiments of the disclosure may provide a personalised identification code. In some examples, the garment identifier may comprise the types of sports kits and sizes, and the user identifier may comprise relevant personal information such as names, heights and sports teams.

Optionally, the method may comprise creating a randomised identification code. Optionally, the method further comprises linking the identification code to the user identifier and/or the garment identifier. Embodiments of the disclosure may allow batch production of sports kits without personalising the identification codes. It will be understood that randomised identification codes may be produced or printed on sports kits without personalising during batch production and the identification code is linked to the user identifier and/or the garment identifier.

Optionally, the identification code may provide a website URL for obtaining the first message. In some examples, the identification code may be used to monitor scanning so that the first message is automatically sent in response to the scanning.

Optionally, the first message may comprise i) the user identifier and/or the garment identifier and ii) information relating to a finder scanning the identification code.

In some examples, the website URL may send the finder to a form page to notify the user of where it was found, the finder that found it and their contact details to retrieve the garment. In another example, the website URL may send the finder to a form page to notify clubs, schools or garment manufacturers.

In some examples, the website URL may be a personalised URL (PURL) is a unique URL that is customised for an individual user based on the user identifier and/or the garment identifier.

Optionally, sending a second message to a user device may comprise identifying the user using a lookup table in a database based on the user identifier and/or the garment identifier.

Optionally, the identification code may comprise a barcode and a two-dimensional QR code.

In one example, the identification code may be a two-dimensional barcode which can store information both horizontally and vertically, allowing it to store much more data than a one-dimensional barcode. A two-dimensional barcode typically consists of a grid of squares or dots that represent the encoded data. Examples of two-dimensional barcodes include QR codes and Data Matrix codes. QR codes can be scanned quickly using a smartphone. This ease of scanning makes them a convenient tool for accessing information or interacting with digital content.

Optionally, the identification code may be printed or attached to the garment. In some examples, a QR code may be printed onto a garment so it cannot be easily removed or damaged during regular use.

Optionally, the method may further comprise saving the identification code in the database and synchronising the identification code with the user identifier and/or the garment identifier in response to the user identifier and/or the garment identifier being updated.

In some examples, the identification code may be a Dynamic QR code: A Dynamic QR code is a type of QR code that can be edited and updated with new information or content. For example, Dynamic QR codes send users on to specific information or web pages, and the URL encoded in them redirects to a second URL that can be changed on demand, even after a code is printed. Therefore, Dynamic QR codes allow updating the content linked to the QR code without changing the actual QR code image. Embodiments of the disclosure allow that the same QR code image continues to be used while the underlying content changes.

The Dynamic QR codes may be sent to factories with no data (i.e. not related to any specific order and not registered).

In one example, after production, the Dynamic QR codes may be registered to the clubs/organisations, or directly to the user, using a registration process (i.e. a QR Code registration scan). The QR code registration scan may be the QR code being scanned for the first time. After registering an individual or a batch of QR codes, the clubs/organisations or the user may add initial details and update the QR codes in the future.

In another example, after kit production, a kit provider may perform a QR Code registration scan before sending kits to the clubs/organisations or the user using all the relevant information in the database. A kit provider is a company or service that offers kits solutions containing a collection of related sports kits or garments.

In one example, the personalised QR code is sent to the factory. The factory prints the QR code on the inside of the garment for sublimated kits or on a label for non-sublimated kits. The garment is then delivered to the customer.

Another aspect of the disclosure provides a server for identifying a garment,
wherein the server is configured to receive a first message in response to an identification code on the garment being scanned;
wherein the server is configured to obtain a user identifier relating to a user of the garment and/or a garment identifier relating to the garment based on the first message;
and wherein the server is configured to send a second message to a user device to confirm the identification of the garment based on the user identifier and/or the garment identifier.

Embodiments of the disclosure may allow the server to identify a lost garment when it is discovered by a finder, notify the owner about the identification of the garment and arrange collection. By using an identification code, personal contact information remains confidential while still allowing the finder to reach out to the owner of a lost garment.

Optionally, the server may be configured to create the identification code based on the user identifier and/or the garment identifier. Embodiments of the disclosure may provide a personalised identification code. In some examples, the garment identifier may comprise the types of sports kits and sizes, and the user identifier may comprise relevant personal information such as names, heights and sports teams.

Optionally, the server may be configured to create a randomised identification code. Optionally, the server is configured to link the identification code to the user identifier and/or the garment identifier. Embodiments of the disclosure may allow batch production of sports kits without personalising the identification code. It will be understood that randomised identification codes may be produced or printed on sports kits without personalising during batch production and the identification code is linked to the user identifier and/or the garment identifier.

Optionally, the server may be configured to provide a website URL in the identification code for obtaining the first message in the identification. In some examples, the identification code may be used to monitor scanning so that the first message is automatically sent in response to the scanning.

Optionally, the first message may comprise i) the user identifier and/or the garment identifier and ii) information relating to a finder scanning the identification code.

Optionally, the server may be configured to identify the user using a lookup table in a database based on the user identifier and/or the garment identifier.

In some examples, the website URL may send the finder to a form page to notify the user of where it was found, the finder that found it and their contact details to retrieve the garment. In another example, the website URL may send the finder to a form page to notify clubs, schools or garment manufacturers.

In some examples, the website URL may be a personalised URL (PURL) is a unique URL that is customised for an individual user based on the user identifier and/or the garment identifier.

Optionally, the identification code may comprise a barcode and a two-dimensional QR code.

In one example, the identification code may be a two-dimensional barcode which can store information both horizontally and vertically, allowing it to store much more data than a one-dimensional barcode. A two-dimensional barcode typically consists of a grid of squares or dots that represent the encoded data. Examples of two-dimensional barcodes include QR codes and Data Matrix codes. QR codes can be scanned quickly using a smartphone. This ease of scanning makes them a convenient tool for accessing information or interacting with digital content.

Optionally, the identification code may be printed or attached to the garment. In some examples, a QR code may be printed onto a garment so it cannot be easily removed or damaged during regular use.

Optionally, the server may be configured to save the identification code in the database and synchronise the identification code with the user identifier and/or the garment identifier in response to the user identifier and/or the garment identifier being updated.

In some examples, the identification code may be a Dynamic QR code. A Dynamic QR code is a type of QR code that can be edited and updated with new information or content. For example, Dynamic QR codes may send users on to specific information or web pages, and the URL encoded in them may redirect to a second URL that can be changed on demand, even after a code is printed. Therefore, Dynamic QR codes allow the content linked to the QR code to be updated without changing the actual QR code image. Embodiments of the disclosure allow the same QR code image to continue to be used while the underlying content changes.

The Dynamic QR codes may be sent to factories with no data (i.e. not related to any specific order and not registered).

In one example, after production, the Dynamic QR codes may be registered to the clubs/organisations, or directly to the user, using a registration process (i.e. a QR Code registration scan). After registering an individual or a batch of QR codes, the clubs/organisations or the user may add initial details and update the QR codes in the future.

In another example, after kit production, a kit provider may perform a QR Code registration scan before sending kits to the clubs/organisations or the user using all the relevant information in the database. Another aspect of the disclosure provides a method for identifying a garment, comprising
scanning an identification code;
sending a first message to a server, wherein the first message is used for obtaining a user identifier relating to a user of the garment and/or a garment identifier relating to the garment, wherein and a second message is sent to a user device to confirm the identification of the garment based on the user identifier and/or the garment identifier.

Embodiments of the disclosure may allow the method to identify a lost garment when it is discovered by a finder, notify the owner about the identification of the garment and arrange collection. By using an identification code, personal contact information remains confidential while still allowing the finder to reach out to the owner of a lost garment.

Optionally, the identification code may be created based on the user identifier and/or the garment identifier. Embodiments of the disclosure may provide a personalised identification code. In some examples, the garment identifier may comprise the types of sports kits and sizes, and the user identifier may comprise relevant personal information such as names, heights and sports teams.

Optionally, the identification code may be randomised. Optionally, the identification code is linked to the user identifier and/or the garment identifier. Embodiments of the disclosure may allow batch production of sports kits without personalising the identification codes. It will be understood that randomised identification codes may be produced or printed on sports kits without personalising during batch production and the identification code is linked to the user identifier and/or the garment identifier.

Optionally, wherein scanning the identification code may comprise visiting a website URL in the identification code for obtaining the first message. In some examples, the identification code may be used to monitor scanning so that the first message is automatically sent in response to the scanning.

Optionally, the first message may comprise i) the user identifier and/or the garment identifier and ii) information relating to a finder scanning the identification code.

In some examples, the website URL may send the finder to a form page to notify the user of where it was found, the finder that found it and their contact details to retrieve the garment. In another example, the website URL may send the finder to a form page to notify clubs, schools or garment manufacturers.

In some examples, the website URL may be a personalised URL (PURL) is a unique URL that is customised for an individual user based on the user identifier and/or the garment identifier.

Another aspect of the disclosure provides a method for manufacturing a garment, comprising
creating an identification code;
attaching or printing the identification code on the garment;
wherein in response to the identification code on the garment being scanned, a first message is sent for obtaining the user identifier and/or the garment identifier and a second message is sent to a user device to confirm the identification of the garment based on the user identifier and/or the garment identifier.

Embodiments of the disclosure may allow a method for manufacturing a garment to identify a lost garment when it is discovered by a finder, notify the owner about the identification of the garment and arrange collection. By using an identification code, personal contact information remains confidential while still allowing the finder to reach out to the owner of a lost garment.

It can be understood that the method may be applied to manufacturing other types of goods and used by manufacturers to register and identify the ownership of the goods. For example, the types of goods may comprise bags such as backpacks and tote bags, luggage such as suitcases, accessories such as jewelleries, belts, wallets and shoes; and portable electronic devices such as mobile phones, laptops, tablets and smart watches.

Optionally, the identification code may be created based on the user identifier and/or the garment identifier. Embodiments of the disclosure may provide a personalised identification code. In some examples, the garment identifier may comprise the types of sports kits and sizes, and the user identifier may comprise relevant personal information such as names, heights and sports teams.

Optionally, the identification code may be randomised. Optionally, the identification code is linked to the user identifier and/or the garment identifier. Embodiments of the disclosure may allow batch production of sports kits without personalising the identification codes. It will be understood that randomised identification codes may be produced or printed on sports kits without personalising during batch production and the identification code is linked to the user identifier and/or the garment identifier.

Optionally, an identification code may provide a website URL for obtaining the first message. In some examples, the identification code may be used to monitor scanning so that the first message is automatically sent in response to the scanning.

Optionally, the first message may comprise i) the user identifier and/or the garment identifier and ii) information relating to a finder scanning the identification code.

In some examples, the website URL may send the finder to a form page to notify the user of where it was found, the finder that found it and their contact details to retrieve the garment. In another example, the website URL may send the finder to a form page to notify clubs, schools or garment manufacturers.

In some examples, the website URL may be a personalised URL (PURL) is a unique URL that is customised for an individual user based on the user identifier and/or the garment identifier.

Optionally, the identification code may comprise a barcode and a two-dimensional QR code.

In one example, the identification code may be a two-dimensional barcode which can store information both horizontally and vertically, allowing it to store much more data than a one-dimensional barcode. A two-dimensional barcode typically consists of a grid of squares or dots that represent the encoded data. Examples of two-dimensional barcodes include QR codes and Data Matrix codes. QR codes can be scanned quickly using a smartphone. This ease of scanning makes them a convenient tool for accessing information or interacting with digital content.

Optionally, the method may further comprise receiving the user identifier and/or the garment identifier by secure form submission.

Optionally, the method may further comprise saving the identification code in the database and synchronising the identification code with the user identifier and/or the garment identifier in response to the user identifier and/or the garment identifier being updated.

In some examples, the identification code may be a Dynamic QR code. A Dynamic QR code is a type of QR code that can be edited and updated with new information or content. For example, Dynamic QR codes may send users on to specific information or web pages, and the URL encoded in them may redirect to a second URL that can be changed on demand, even after a code is printed. Therefore, Dynamic QR codes allow the content linked to the QR code to be updated without changing the actual QR code image. Embodiments of the disclosure allow the same QR code image to continue to be used while the underlying content changes.

The Dynamic QR codes may be sent to factories with no data (i.e. not related to any specific order and not registered).

In one example, after production, the Dynamic QR codes may be registered to the clubs/organisations, or directly to the user, using a registration process (i.e. a QR Code registration scan). After registering an individual or a batch of QR codes, the clubs/organisations or the user may add initial details and update the QR codes in the future.

In another example, after kit production, a kit provider may perform a QR Code registration scan before sending kits to the clubs/organisations or the user using all the relevant information in the database.

### DRAWINGS

Embodiments of the disclosure will now be described, by way of example only, with reference to the accompanying drawings, in which:

FIG. 1 is an illustration of a diagram of a method for identifying a garment.

FIG. 2 is an illustration of an example of a system for identifying a garment.

FIG. 3 is a functional block diagram of an example of a mobile device, a user device and server for use with the system and method of any of FIGS. 1 to 2.

FIG. 4 is an illustration of a diagram of a method for manufacturing a garment.

FIG. 5 is an illustration of an example of a system for manufacturing a garment.

FIG. 6 is an illustration of an example of a method and system for manufacturing and registering a garment.

FIG. 7 is an illustration of another example of a method and system for manufacturing and registering a garment.

### SPECIFIC DESCRIPTION

The following detailed description illustrates exemplary embodiments of the present disclosure and the ways in which they can be implemented. Although some modes of carrying out the present disclosure have been disclosed, those skilled in the art would recognize that other embodiments for carrying out or practising the present disclosure are also possible.

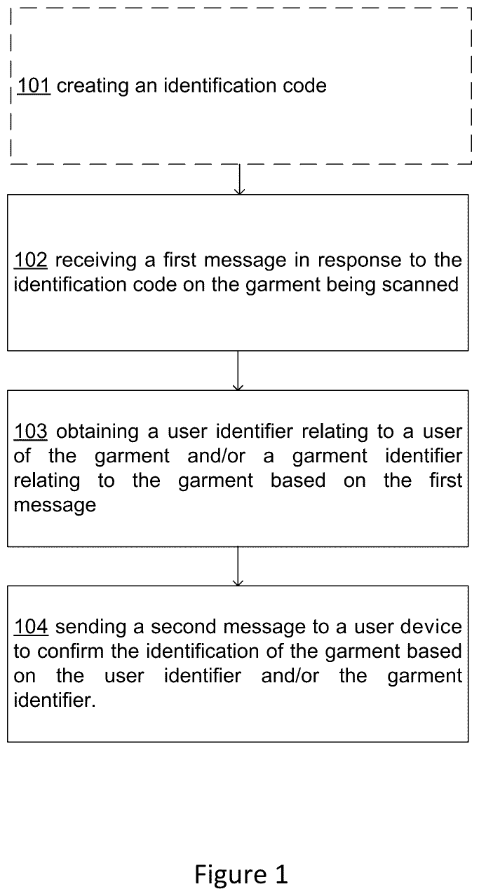

FIG. 1 is an illustration of a diagram of a method for identifying a garment. This method allows identifying a lost garment when it is discovered by a finder, notifying the owner about the identification of the garment and arranging collection. By using an identification code, personal contact information remains confidential while still allowing the finder to reach out to the owner of a lost garment.

A server creates 101 an identification code. It will be understood that the server may create the identification code based on the user identifier and/or the garment identifier to provide a personalised identification code. In some examples, the garment identifier may comprise the types of sports kits and sizes, and the user identifier may comprise relevant personal information such as names, heights and sports teams.

Alternatively, the server may create a randomised identification code. It will be understood that randomised identification codes may be produced or printed on sports kits without personalising during batch production and the identification code is linked to the user identifier and/or the garment identifier.

The identification code may comprise a barcode and a two-dimensional QR code. A Two-dimensional barcode typically consists of a grid of squares or dots that represent the encoded data. Examples of two-dimensional barcodes include QR codes and Data Matrix codes. QR codes can be scanned quickly using a smartphone. This ease of scanning makes them a convenient tool for accessing information or interacting with digital content.

In some examples, the identification code is a Dynamic QR code. A Dynamic QR code is a type of QR code that can be edited and updated with new information or content. For example, Dynamic QR codes may send users on to specific information or web pages, and the URL encoded in them may redirect to a second URL that can be changed on demand, even after a code is printed. Therefore, Dynamic QR codes allow the content linked to the QR code to be updated without changing the actual QR code image. This allows the same QR code image to continue to be used while the underlying content changes.

The Dynamic QR codes may be sent to factories with no data (i.e. not related to any specific order and not registered).

In one example, after production, the Dynamic QR codes may be registered to the clubs/organisations, or directly to the user, using a registration process (i.e. a QR Code registration scan). After registering an individual or a batch of QR codes, the clubs/organisations or the user may add initial details and update the QR codes in the future.

In another example, after kit production, a kit provider may perform a QR Code registration scan before sending kits to the clubs/organisations or the user using all the relevant information in the database.

In one example, a user purchases a sport kit having a randomised QR code, the QR code on the sport kit is linked to the user.

The server receives 102 a first message in response to the identification code on the garment being scanned.

In some examples, the identification code may be used to monitor scanning so that the first message is automatically sent to the server in response to the scanning so that the server notifies the owner that the garment is found.

In another example, the server may provide a website URL in the identification code for obtaining the first message. In some examples, the website URL may send the finder to a form page to notify the user of where it was found, the finder that found it and their contact details to retrieve the garment. In another example, the website URL may send the finder to a form page to notify clubs, schools or garment manufacturers instead of the owner so that the owner's privacy is further protected.

In some examples, the website URL may be a personalised URL (PURL) is a unique URL that is customised for an individual user based on the user identifier and/or the garment identifier.

The server obtains 103 a user identifier relating to a user of the garment and/or a garment identifier relating to the garment based on the first message.

It will be understood that the first message may comprise i) the user identifier and/or the garment identifier and ii) information relating to a finder scanning the identification code. The server may identify the user using a lookup table in a database based on the user identifier and/or the garment identifier. In some examples, the server may obtain the user's contact details to send the identification of the garment to the user.

The server sends 104 a second message to a user device to confirm the identification of the garment based on the user identifier and/or the garment identifier.

It will be understood that the identification code may be printed or attached to the garment. In some examples, a QR code is printed onto a garment so it cannot be easily removed or damaged during regular use.

The identification code may be in the database of the server and synchronised with the user identifier and/or the garment identifier in response to the user identifier and/or the garment identifier being updated.

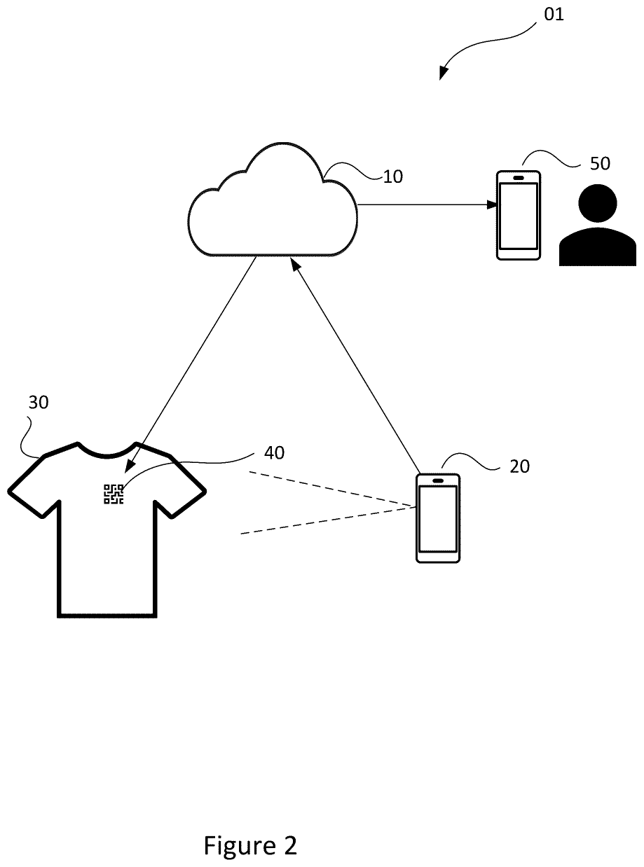

FIG. 2 Is an illustration of an example of a system for identifying a garment.

The system 01 comprises a server 10 configured to create an identification code 40 for a garment 30. It will be understood that the server 10 may create the identification code 40 based on the user identifier and/or the garment identifier to provide a personalised identification code. In some examples, the garment identifier may comprise the types of sports kits and sizes, and the user identifier may comprise relevant personal information such as names, heights and sports teams.

Alternatively, the server 10 may create a randomised identification code 40. It will be understood that randomised identification codes 40 may be produced or printed on sports kits without personalising during batch production and the identification code 40 is linked to the user identifier and/or the garment identifier.

The identification code 40 may comprise a barcode and a two-dimensional QR code. A two-dimensional barcode typically consists of a grid of squares or dots that represent the encoded data. Examples of two-dimensional barcodes include QR codes and Data Matrix codes. QR codes can be scanned quickly using a smartphone. This ease of scanning makes them a convenient tool for accessing information or interacting with digital content.

In some examples, the identification code 40 is a Dynamic QR code. A Dynamic QR code is a type of QR code that can be edited and updated with new information or content. For example, Dynamic QR codes may send users on to specific information or web pages, and the URL encoded in them may redirects to a second URL that can be changed on demand, even after a code is printed. Therefore, Dynamic QR codes allow the content linked to the QR code to be updated without changing the actual QR code image. This allows that the same QR code image to continue to be used while the underlying content changes.

In one example, a user purchases a sport kit having a randomised QR code, the QR code on the sport kit is linked to the user.

The system 01 further comprises a mobile device 20 configured to scan the identification code 40 to obtain a first message and send the first message to the server 10. In some examples, the identification code 40 may be used to monitor scanning so that the first message is automatically sent to the server 10 in response to the scanning so that the server 10 notifies the owner that the garment 30 is found.

The server 10 is configured to receive the first message from the mobile device 20 in response to the identification code 40 on the garment 30 being scanned.

In some examples, the server 10 may provide a website URL in the identification code 40 for obtaining the first message. In some examples, the website URL may send the finder to a form page to notify the user of where it was found, the finder that found it and their contact details to retrieve the garment 30. In another example, the website URL may send the finder to a form page to notify clubs, schools or garment manufacturers instead of the owner so that the owner's privacy is further protected.

In some examples, the website URL may be a personalised URL (PURL) is a unique URL that is customised for an individual user based on the user identifier and/or the garment identifier.

The server 10 obtains a user identifier relating to a user of the garment 30 and/or a garment identifier relating to the garment 30 based on the first message.

It will be understood that the first message may comprise i) the user identifier and/or the garment identifier and ii) information relating to a finder scanning the identification code 40. The server 10 may identify the user using a lookup table in a database based on the user identifier and/or the garment identifier. In some examples, the server 10 may obtain the user's contact details to send the identification of the garment 30 to the user.

The server 10 is configured to send a second message to a user device 50 to confirm the identification of the garment 30 based on the user identifier and/or the garment identifier. The user device 50 is configured to receive the second message from the server 10.

It will be understood that the identification code 40 may be printed or attached to the garment. In some examples, a QR code 40 is printed onto a garment 30 so it cannot be easily removed or damaged during regular use.

The identification code 40 may be saved in the database of the server 10 and synchronised with the user identifier and/or the garment identifier in response to the user identifier and/or the garment identifier being updated.

In one example, the user agrees to have a QR code 40 printed on the inside of a sports kit, the server 10 is configured to create the QR code 40. Every QR code 40 is kept in secure database and synchronised with the user identifier and/or garment identifier such as the details of the sports kit, sizes, and relevant personal information. Website creation with secure form submission is synchronised to the QR code database. The QR code 40 is sent to the factory with the personalised order. The factory prints the QR code 40 on the inside of the item of clothing for sublimated kits or on a label for non-sublimated kits. A sports kit is delivered to the customer.

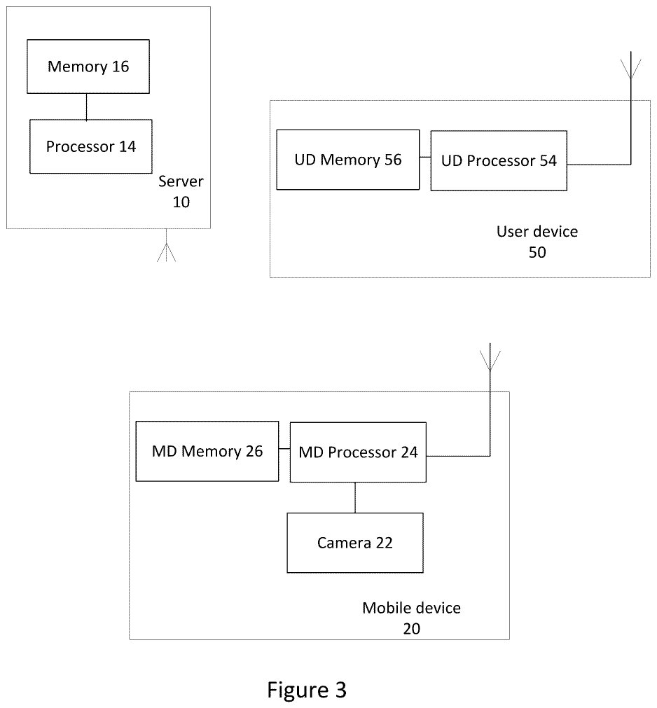

If the user loses the sports kit, the sports kit can be identified by a simple scanning by the finder's mobile device 20. After scanning the QR code 40, the finder's mobile device 20 is sent to a form page to identify the user identifier and/or garment identifier and notify the garment manufacturers or the user of where it was found, the finder and the contact details to retrieve the sports kit. The scanning automatically sends a message to the server 10 which then sends a message to the user device 50 detailing where the garment was found. FIG. 3 is a functional block diagram of an example of a mobile device, a user device and server for use with the system and method of any of FIGS. 1 to 2.

The server 10 comprises a processor 14 and a memory 16. The mobile device 20 comprises a camera 22, a MD processor 24 and a MD memory 26. The user device 50 comprises a UD processor 54 and a UD memory 56.

The mobile device 20 is configured to scan the identification code on the garment using the camera 22 to obtain a first message and send the first message to the server 10. In some examples, the identification code may be used to monitor scanning so that the first message is automatically sent to the server in response to the scanning so that the server notifies the owner that the garment is found.

The server 10 is configured to create the identification code for a garment. It will be understood that the server 10 may create the identification code based on the user identifier and/or the garment identifier to provide a personalised identification code. In some examples, the garment identifier may comprise the types of sports kits and sizes, and the user identifier may comprise relevant personal information such as names, heights and sports teams. The user identifiers and/or the garment identifiers may be saved in the memory 16 as a look-up table.

The server 10 is configured to receive the first message from the mobile device 20 in response to the identification code on the garment being scanned. The server 10 is configured to send a second message to a user device 50 to confirm the identification of the garment 30 based on the user identifier and/or the garment identifier.

In some examples, the server 10 is configured to save the identification code in the database in the memory 16 and synchronise the identification code with the user identifier and/or the garment identifier in response to the user identifier and/or the garment identifier being updated.

The user device 50 is configured to receive the second message from the server 10.

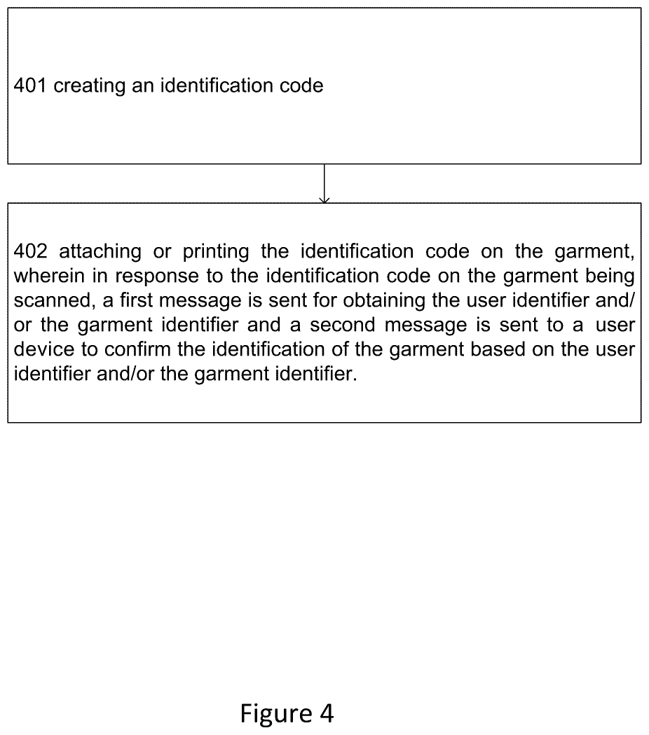

FIG. 4 is an illustration of a diagram of a method for manufacturing a garment.

A server creates 401 an identification code; and attach or print 402 the identification code on the garment; wherein in response to the identification code on the garment being scanned, a first message is sent for obtaining the user identifier and/or the garment identifier and a second message is sent to a user device to confirm the identification of the garment based on the user identifier and/or the garment identifier.

In some examples, the identification code is created based on the user identifier and/or the garment identifier. This provides a personalised identification code. In some examples, the garment identifier may comprise the types of sports kits and sizes, and the user identifier may comprise relevant personal information such as names, heights and sports teams. The server may receive the user identifier and/or the garment identifier by secure form submission by the user.

In another example, the identification code is randomised. Optionally, the identification code is linked to the user identifier and/or the garment identifier. This allows batch production of sports kits without personalising the identification code. It will be understood that randomised identification codes may be produced or printed on sports kits without personalising during batch production and the identification code is linked to the user identifier and/or the garment identifier.

An identification code may provide a website URL for obtaining the first message. In some examples, the identification code may be used to monitor scanning so that the first message is automatically sent in response to the scanning.

Optionally, the first message comprises i) the user identifier and/or the garment identifier and ii) information relating to a finder scanning the identification code.

In some examples, the website URL may send the finder to a form page to notify the user of where it was found, the finder that found it and their contact details to retrieve the garment. In another example, the website URL may send the finder to a form page to notify clubs, schools or garment manufacturers.

In some examples, the website URL may be a personalised URL (PURL) is a unique URL that is customised for an individual user based on the user identifier and/or the garment identifier.

In one example, the identification code may be a two-dimensional barcode which can store information both horizontally and vertically, allowing it to store much more data than a one-dimensional barcode. A two-dimensional barcode typically consists of a grid of squares or dots that represent the encoded data. Examples of two-dimensional barcodes include QR codes and Data Matrix codes. QR codes can be scanned quickly using a smartphone. This ease of scanning makes them a convenient tool for accessing information or interacting with digital content.

Optionally, the method further comprises saving the identification code in the database and synchronising the identification code with the user identifier and/or the garment identifier in response to the user identifier and/or the garment identifier being updated.

In some examples, the identification code is a Dynamic QR code. A Dynamic QR code is a type of QR code that can be edited and updated with new information or content. For example, Dynamic QR codes may send users on to specific information or web pages, and the URL encoded in them may redirect to a second URL that can be changed on demand, even after a code is printed. Therefore, Dynamic QR codes may allow the content linked to the QR code to be updated without changing the actual QR code image. Embodiments of the disclosure allow the same QR code image to continue to be used while the underlying content may change.

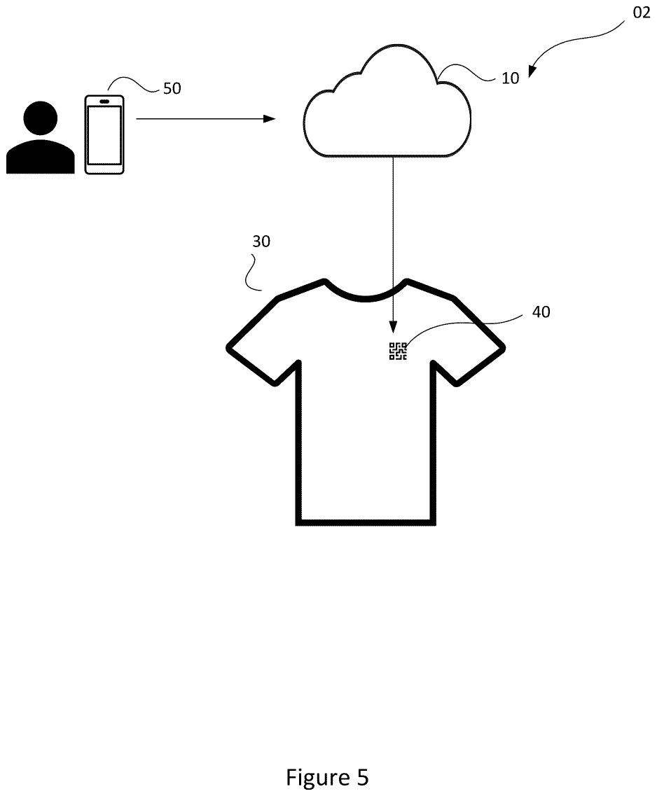

FIG. 5 Is an illustration of an example of a system 02 for manufacturing a garment 30.

The system 02 comprises a server 10 configured to receive the user identifier and/or the garment identifier from a user device 50. The server 10 may receive the user identifier and/or the garment identifier by secure form submission by the user. In some examples, the garment identifier may comprise the types of sports kits and sizes, and the user identifier may comprise relevant personal information such as names, heights and sports teams.

The server 10 is configured to create an identification code and attach or print the identification code 40 on the garment 30; wherein in response to the identification code 40 on the garment 30 being scanned by the mobile device 20, a first message is sent to the server 10 for obtaining the user identifier and/or the garment identifier and a second message is sent to a user device to confirm the identification of the garment 30 based on the user identifier and/or the garment identifier.

The identification code 40 may be created based on the user identifier and/or the garment identifier. This provides a personalised identification code 40. Alternatively, the identification code 40 is randomised. Optionally, the identification code 40 is linked to the user identifier and/or the garment identifier. This allows batch production of sports kits without personalising the identification code 40. It will be understood that randomised identification codes 40 may be produced or printed on sports kits without personalising during batch production and then the identification code 40 is linked to the user identifier and/or the garment identifier.

In one example, the identification code 40 may be a two-dimensional barcode which can store information both horizontally and vertically, allowing it to store much more data than a one-dimensional barcode. A two-dimensional barcode typically consists of a grid of squares or dots that represent the encoded data. Examples of two-dimensional barcodes include QR codes and Data Matrix codes. QR codes can be scanned quickly using a smartphone. This ease of scanning makes them a convenient tool for accessing information or interacting with digital content.

In some examples, the identification code 40 is a Dynamic QR code. A Dynamic QR code is a type of QR code that can be edited and updated with new information or content. For example, Dynamic QR codes may send users on to specific information or web pages, and the URL encoded in them may redirect to a second URL that can be changed on demand, even after a code is printed. Therefore, Dynamic QR codes allow the content linked to the QR code to be updated without changing the actual QR code image. This allows the same QR code image to continue to be used while the underlying content changes. In one example, the personalised QR code is sent to the factory. The factory prints the QR code on the inside of the garment 30 for sublimated kits or on a label for non-sublimated kits. The garment 30 is then delivered to the customer.

An identification code 40 may provide a website url for obtaining the first message. In some examples, the identification code 40 may be used to monitor scanning so that the first message is automatically sent in response to the scanning.

Optionally, the first message comprises i) the user identifier and/or the garment identifier and ii) information relating to a finder scanning the identification code 40.

In some examples, the website URL may send the finder to a form page to notify the user of where it was found, the finder that found it and their contact details to retrieve the garment. In another example, the website URL may send the finder to a form page to notify clubs, schools or garment manufacturers.

In some examples, the website URL may be a personalised URL (PURL) is a unique URL that is customised for an individual user based on the user identifier and/or the garment identifier.

Optionally, the identification code 40 is saved in the database in the server 10 and synchronising the identification code 40 with the user identifier and/or the garment identifier in response to the user identifier and/or the garment identifier being updated.

It will be appreciated from the discussion above that the embodiments shown in the Figures are merely exemplary, and include features which may be generalised, removed or replaced as described herein and as set out in the claims. In the context of the present disclosure other examples and variations of the apparatus and methods described herein will be apparent to a person of skill in the art.

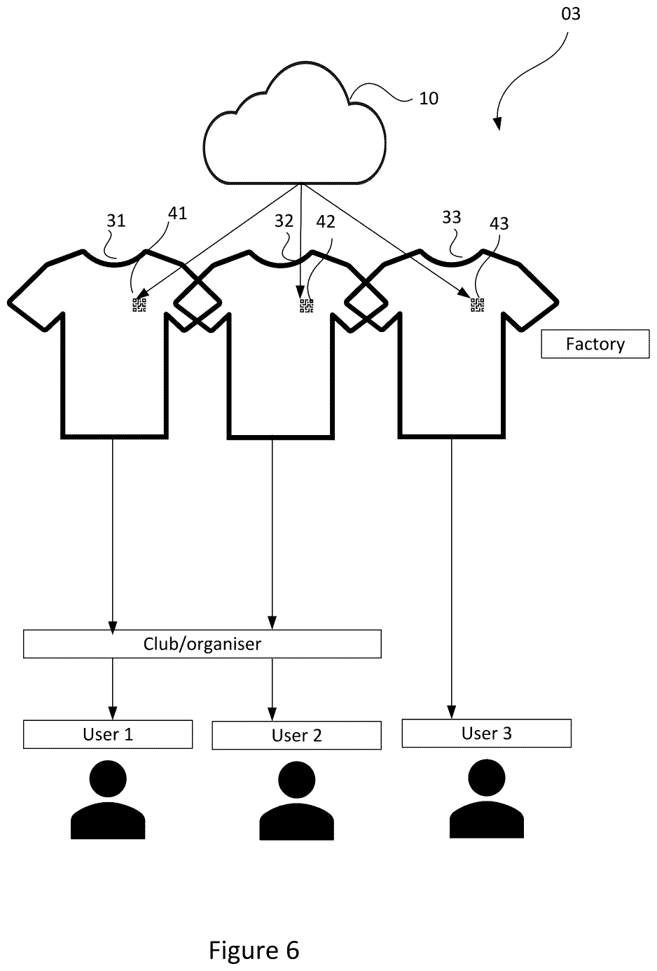

FIG. 6 is an illustration of an example of a method and system for manufacturing and registering a garment.

The system 03 comprises a server 10 configured to create three Dynamic QR codes 41, 42 and 43.

A Dynamic QR code is a type of QR code that can be edited and updated with new information or content. For example, Dynamic QR codes may send users on to specific information or web pages, and the URL encoded in them may redirect to a second URL that can be changed on demand, even after a code is printed. Therefore, Dynamic QR codes allow the content linked to the QR code to be updated without changing the actual QR code image. This allows the same QR code image to continue to be used while the underlying Content Changes.

The Dynamic QR codes 41, 42 and 43 are sent to factories producing garments. The Dynamic QR codes 41, 42 and 43 contain no data (i.e. not related to any specific order and not registered).

After production, the dynamic QR codes 41, 42 and 43 are printed on garments 31, 32 and 33 respectively.

Later, the Dynamic QR codes 41 and 42 are registered to User 1 and User 2 under a club/organisation and the Dynamic QR code 43 is directly registered to User 3 by a registration process (i.e. a QR Code registration scan) . For example, the Dynamic QR code 41 is linked to the user identifier of User 1 and the garment identifier of garment 31 after the QR Code registration scan done by the club/organisation.

After registering an individual or a batch of QR codes, the club/organisation may add initial details and update Dynamic QR codes 41 and 42 for User 1 and User 2, and User 3 may add initial details and update the Dynamic QR code 43 in the future.

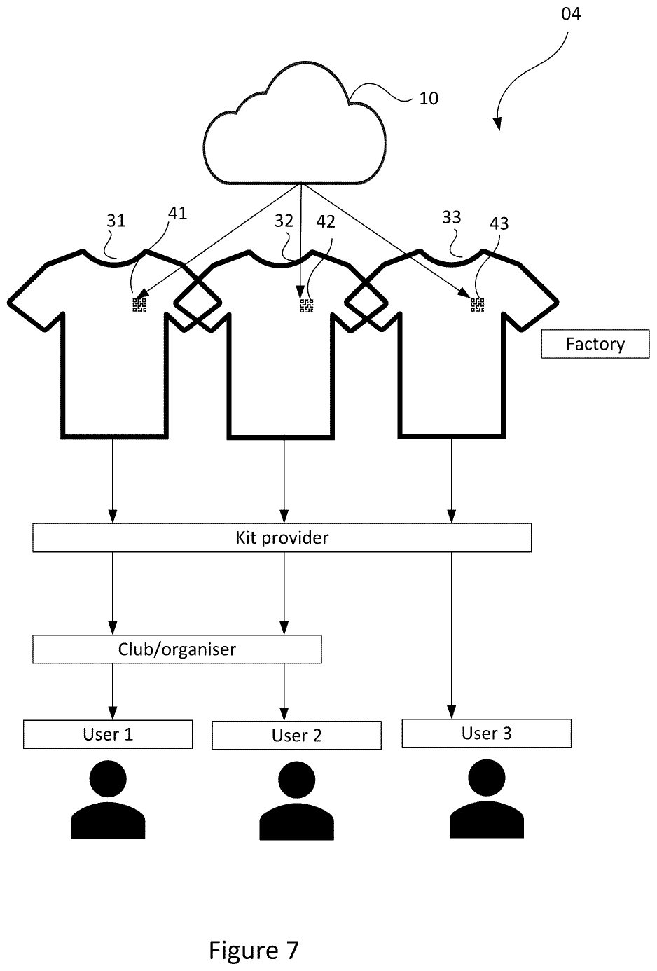

FIG. 7 is an illustration of another example of a method and system for manufacturing and registering a garment.

The system 04 comprises a server 10 configured to create three Dynamic QR codes 41, 42 and 43.

A Dynamic QR code is a type of QR code that can be edited and updated with new information or content. For example, Dynamic QR codes may send users on to specific information or web pages, and the URL encoded in them may redirect to a second URL that can be changed on demand, even after a code is printed. Therefore, Dynamic QR codes allow updating the content linked to the QR code without changing the actual QR code image. This allows the same QR code image to continue to be used while the underlying content changes.

The Dynamic QR codes 41, 42 and 43 are sent to factories producing garments. The Dynamic QR codes 41, 42 and 43 contain no data (i.e. not related to any specific order and not registered).

After production, the Dynamic QR codes 41, 42 and 43 are printed on garments 31, 32 and 33 respectively.

Later, a kit provider may perform a registration process (i.e. a QR Code registration scan) before sending kits to the clubs/organisations or the user using all the relevant information in the database, to register the Dynamic QR codes 41 and 42 to User 1 and User 2 under a club/organisation, and directly register the Dynamic QR code 43 to the User 3. For example, the Dynamic QR code 41 is linked to the user identifier of User 1 and the garment identifier of garment 31 after the QR Code registration scan done by the kit provider.

The kit provider is a company or service that offers kits solutions containing a collection of related sports kits or garments.

After registering an individual or a batch of QR codes, the kit provider may update the Dynamic QR codes 41, 42 and 43 on behalf of the club/organisation or the user in the future. Additionally, or alternatively, the club/organisation may update Dynamic QR codes 41 and 42 for User 1 and User 2, and the User 3 may update Dynamic QR code 43 in the future.

1. A method for identifying a garment, comprising:
receiving a first message in response to an identification code on the garment being scanned;
obtaining a user identifier relating to a user of the garment and/or a garment identifier relating to the garment based on the first message;
sending a second message to a user device to confirm the identification of the garment based on the user identifier and/or the garment identifier;
the method further comprises saving the identification code in a database and synchronising the identification code with the user identifier and/or the garment identifier in response to the user identifier and/or the garment identifier being updated.

2. The method of claim 1, wherein the method further comprises creating the identification code based on the user identifier and/or the garment identifier.

3. The method of claim 1, wherein the method further comprises creating a randomised identification code.

4. The method of claim 3, wherein the method further comprises linking the identification code to the user identifier and/or the garment identifier.

5. The method of claim 1, wherein the identification code provides a website URL for obtaining the first message.

6. The method of claim 1, any wherein the first message comprises i) the user identifier and/or the garment identifier and ii) information relating to a finder scanning the identification code.

7. The method of claim 1, any wherein sending a second message to a user device comprises identifying the user using a lookup table in the database based on the user identifier and/or the garment identifier.

8. The method of claim 1, any wherein the identification code comprises a barcode and a two-dimensional QR code, and/or wherein the identification code is printed or attached to the garment.

9. (canceled)

10. A server for identifying a garment,
wherein the server is configured to receive a first message in response to an identification code on the garment being scanned;
wherein the server is configured to obtain a user identifier relating to a user of the garment and/or a garment identifier relating to the garment based on the first message;
and wherein the server is configured to send a second message to a user device to confirm the identification of the garment based on the user identifier and/or the garment identifier;
wherein the server is configured to save the identification code in a database and synchronise the identification code with the user identifier and/or the garment identifier in response to the user identifier and/or the garment identifier being updated.

11. The server of claim 10, wherein the server is configured to create the identification code based on the user identifier and/or the garment identifier, or wherein the server is configured to create a randomized identification code.

12. (canceled)

13. The server of claim 11, wherein the server is configured to link the identification code to the user identifier and/or the garment identifier.

14. The server of any of claim 10, wherein the identification code provides a website URL for obtaining the first message in the identification.

15. The server of any of claim 10, wherein the first message comprises i) the user identifier and/or the garment identifier and ii) information relating to a finder scanning the identification code, and/or the server is configured to identify the user using a lookup table in the database based on the user identifier and/or the garment identifier, and/or wherein the identification code comprises a barcode and a two-dimensional QR code, and/or wherein the identification code is printed or attached to the garment.

16. (canceled)

17. (canceled)

18. (canceled)

19. A method for identifying a garment, comprising:
scanning an identification code;
sending a first message to a server, wherein the first message is used for obtaining a user identifier relating to a user of the garment and/or a garment identifier relating to the garment, wherein and a second message is sent to a user device to confirm the identification of the garment based on the user identifier and/or the garment identifier;
wherein the server is configured to save the identification code in a database and synchronise the identification code with the user identifier and/or the garment identifier in response to the user identifier and/or the garment identifier being updated.

20. The method of claim 19, wherein the identification code is created based on the user identifier and/or the garment identifier, or wherein the identification code is randomized, preferably wherein the identification code is linked to the user identifier and/or the garment identifier.

21. (canceled)

22. (canceled)

23. The method of claim 19, any wherein scanning the identification code comprise visiting a website URL in the identification code for obtaining the first message, and/or wherein the first message comprises i) the user identifier and/or the garment identifier and ii) information relating to a finder scanning the identification code.

24. (canceled)

25. A method for manufacturing a garment, comprising:
creating an identification code;
attaching or printing the identification code on the garment;
wherein in response to the identification code on the garment being scanned, a first message is sent for obtaining the user identifier and/or the garment identifier and a second message is sent to a user device to confirm the identification of the garment based on the user identifier and/or the garment identifier;
the method further comprises saving the identification code in a database and synchronising the identification code with the user identifier and/or the garment identifier in response to the user identifier and/or the garment identifier being updated.

26. The method of claim 25, wherein the identification code is created based on the user identifier and/or the garment identifier, or wherein the identification code is randomized, preferably wherein the identification code is linked to the user identifier and/or the garment identifier.

27. (canceled)

28. (canceled)

29. The method of claim 25, any wherein the identification code provides a website URL for obtaining the first message, and/or wherein the first message comprises i) the user identifier and/or the garment identifier and ii) information relating to a finder scanning the identification code, and/or wherein the identification code comprises a barcode and a two-dimensional QR code, and/or wherein the method further comprises receiving the user identifier and/or the garment identifier by secure form submission.

30. (canceled)

31. (canceled)

32. (canceled)

33. A non-transitory computer-readable medium storing instructions that perform the method of claim 1.
